(19) United States
(12) Patent Application Publication
(10) Pub. No.: US 2006/0100378 A1
(43) Pub. Date: May 11, 2006

(54) Material for making anti-slip shoe sole

(76) Inventor: Kun-Ho Wu, Taichung (TW)

Correspondence Address: Kun-Ho Wu, P.O. Box 55-124, Taichung, TW

(21) Appl. No.: 11/203,307

(22) Filed: Aug. 15, 2005

(30) Foreign Application Priority Data
Nov. 11, 2004 (CN) 200410094638.2

(51) Int. Cl. C08L 9/02; C08L 27/06; A43B 13/02

(52) U.S. Cl. 525/233

(57) ABSTRACT

A material for making a shoe sole includes PVC (polyvinyl chloride) 100 parts by weight, DINP (plasticizer) 45-90 parts by weight, swelling powder 1-5 parts by weight, stabilizator 1-1.5 parts by weight, and foaming powder 0.5-4 parts by weight.

### FIELD OF THE INVENTION

The present invention relates to a material for making anti-slip shoe sole.

### BACKGROUND OF THE INVENTION

A conventional shoe sole is made by foam which lacks some features for preventing from slipping on an oily and wet ground. Some people work on oily and wet ground so that they choose the shoe sole with serrated surface which provides better grasp on the ground. The way that the shoe sole has better grasp is teeth-like pattern defined in the shoe sole. However, the recesses between the teeth-like pattern are easily stuffed by objects such as mud, combination of oil and dust or the like, once the recesses are filled with these objects, the friction between the shoe sole and the ground is reduced. The inherent shortcoming of the conventional shoe soles cannot be overcome by existed material.

The present invention intends to provide a shoe sole made of the material including polyvinyl chloride, plasticizer, swelling powder, stabilizator, and foaming powder.

### SUMMARY OF THE INVENTION

The present invention relates to The present invention intends to provide a shoe sole made of the material including polyvinyl chloride 100 parts by weight, plasticizer 45-90 parts by weight, swelling powder 1-5 parts by weight, stabilizator 1-1.5 parts by weight, and foaming powder 0.5-4 parts by weight.

### DETAILED DESCRIPTION OF THE PREFERRED EMBODIMENT

The shoe sole of the present invention is made by the material which includes the following components:

PVC (polyvinyl chloride): them embodiments for the PVC are polyvinyl chloride powder or polyvinyl chloride particles.

DINP (diisononyl phthalate).

Swelling powder: hydrocarbon coated with acrylic casing.

Stabilizator: cadmium-barium-lead stabilizers.

Foaming powder: Ammonium carborate.

Coloring material: titanium white.

Butadiene-acrylonitrile rubber.

Anti-slip agent: drganic copolymer.

Friction durable agent: Polyethylene copolymer.

A first embodiment of the material for a single color shoe sole of the present invention is composed of the following components:

PVC (polyvinyl chloride) 100 parts by weight,

DINP 45-90 parts by weight,

Swelling powder 1-5 parts by weight,

Stabilizator 1-1.5 parts by weight,

Foaming powder 0.5-1 part by weight, and

Coloring material 0.5-1 part by weight.

The PVC powder is mixed with DINP and heated in a bucket and let the mixture cool down. Swelling powder, stabilizator, foaming powder and coloring material are put in the mixture and stir them for 20 minutes. The final mixture is injected by injection molding machine under injection pressure of 70-140 kg/cm² and temperature of 120-170° C.

The second embodiment of the material of the present invention is for a shoe sole that includes a middle layer and a bottom layer. The middle and bottom layers have different colors. The material for the middle layer of the shoe sole is composed of the following components:

PVC (polyvinyl chloride) 100 parts by weight,

DINP 90 parts by weight,

Swelling powder 1-5 parts by weight,

Stabilizator 1-1.5 parts by weight,

Foaming powder 0.5-4 parts by weight, and

Coloring material 0.4-3 parts by weight.

The material for the bottom layer of the shoe sole is composed of the following components:

PVC (polyvinyl chloride) 100 parts by weight,

Butadiene-acrylonitrile rubber 100-160 parts by weight,

Drganic copolymer 1.5-3 parts by weight, and

Polyethylene copolymer 3-10 parts by weight.

The processes for making the middle layer are the same as that of the first embodiment. The processes of the bottom layer are the same as that of the first embodiment except that the PVC (polyvinyl chloride), the Butadiene-acrylonitrile rubber and the Polyethylene copolymer are mixed at 120-200° C. for 15 minutes till the mixture gelatinizes.

The gelatinized mixture is injected by injection molding machine under injection pressure of 70-140 kg/cm² and temperature of 120-170° C. Two different materials are injected in the same time to obtain a two-layer shoe sole. The shoe sole includes a rough bottom with a plurality of bosses extending therefrom and a flat outer surface. The weight is light because the welling powder.

A third embodiment of the material for a single color shoe sole of the present invention is composed of the following components:

PVC (polyvinyl chloride) 100 parts by weight,

DINP 45-80 parts by weight,

Butadiene-acrylonitrile rubber 1-30 parts by weight,

Stabilizator 1-1.5 parts by weight,

Foaming powder 0.5-1 part by weight,

Coloring material 0.5-1 part by weight, and

Flowing agent 0.5-1.5 parts by weight.

The PVC powder is mixed with DINP and heated in a bucket and the heat is removed after the mixture is dried. After the mixture is cool down, swelling powder, stabilizator, foaming powder, coloring material and flowing agent are put in the mixture and stir them for 20 minutes until the final mixture is gelatinized under 120-200° C. The final mixture is injected in an injection molding machine cooperated with a blowing molding mold to have the shoe sole. The injection pressure is 70-140 kg/cm² and temperature of 130-200° C. The shoe sole of the third embodiment has a smooth surface.

The fourth embodiment of the material of the present invention is for a shoe sole that includes a middle layer and a bottom layer. The middle layer and the bottom layer have different colors. The material for the middle layer of the shoe sole is composed of the following components:

PVC (polyvinyl chloride) 100 parts by weight,

DINP 90 parts by weight,

Swelling powder 1-5 parts by weight,

Stabilizator 1-1.5 parts by weight,

Foaming powder 0.5-1 part by weight, and

Coloring material 0.04 part by weight.

The material for the bottom layer of the shoe sole is composed of the following components:

PVC (polyvinyl chloride) 100 parts by weight,

Butadiene-acrylonitrile rubber 100-110 parts by weight,

Drganic copolymer 1.5-3 parts by weight, and

Polyethylene copolymer 3-10 parts by weight.

The processes for making the middle layer are the same as that of the first embodiment and the processes of the bottom layer are the same as that of the second embodiment.

The material is injected by injection molding machine under injection pressure of 70-140 kg/cm² and temperature of 130-200° C. Two different materials are injected in the same time to obtain the shoe sole. The shoe sole includes a rough bottom with a plurality of bosses extending therefrom and a flat outer surface.

These embodiments mentioned above do not have liquid prints as conventional shoe soles made by way of injection molding. The shoe sole made by the material of the present invention includes the following features:

Specific weight 0.65-0.75

Fastness to crocking over 80%

No bending prints after bending 100000 times at 23° C.

Oil and water are difficult to attach on the shoe soles.

While we have shown and described the embodiment in accordance with the present invention, it should be clear to those skilled in the art that further embodiments may be made without departing from the scope of the present invention.

What is claimed is:

1. A material for making a shoe sole, comprising:
PVC (polyvinyl chloride) 100 parts by weight, DINP (plasticizer) 45-90 parts by weight, swelling powder 1-5 parts by weight, stabilizator 1-1.5 parts by weight, and foaming powder 0.5-4 parts by weight.

2. The material as claimed in claim 1 further comprising butadiene-acrylonitrile rubber 1030 parts by weight and flowing agent 0.5-1.5 parts by weight, the material is mixture at 120-200° C. to be gelatinized.

3. The material as claimed in claim 1 further comprising coloring material 0.04-3 parts by weight.

4. The material as claimed in claim 1, wherein the shoe sole includes a middle layer and a bottom layer, the bottom layer of the shoe sole is composed of the following components:
PVC (polyvinyl chloride) 100 parts by weight,
Butadiene-acrylonitrile rubber 100-160 parts by weight,
Drganic copolymer 1.5-3 parts by weight,
Polyethylene copolymer 3-10 parts by weight, and the material being mixture at 120-200° C. to be gelatinized.
